(19) United States
(12) Patent Application Publication
(10) Pub. No.: US 2007/0214177 A1
(43) Pub. Date: Sep. 13, 2007

(54) Document management system, program and method

(75) Inventor: Akihiko Fujiwara, Yokohama-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/373,766

(22) Filed: Mar. 10, 2006

(51) Int. Cl. G06F 7/00

(52) U.S. Cl. 707/104.1

(57) ABSTRACT

There is provided a document management system in which metadata based on a document manipulation operation, together with the document, is easily registered, and it is possible to eliminate the necessity of performing hierarchical management or separately setting metadata. There are included a document input/output system control module to control a document input/output equipment, a document data management module to manage a document, a document metadata management module to manage metadata relating to the document managed by the document data management module, a business relevant metadata management module to manage metadata relevant to a business relating to the document managed by the document data management module, a document input/output operation metadata collection module to acquire metadata relating to an input/output operation of the document in the document input/output system control module, a metadata relevance calculation module to calculate a relevance among the metadata managed by the document metadata management module, the business relevant metadata management module, and the document input/output operation metadata collection module, and a metadata relevance presentation module to digitize the relevance calculated by the metadata relevance calculation module and to present it to a user.

### BACKGROUND OF THE INVENTION

1. Field of the Invention

The present invention relates to a document management system, program and method, in which metadata based on a document manipulation operation, together with the document, can be easily registered.

2. Description of the Related Art

In a conventional document management system, as a unit to manage documents, there has been one to classify the documents by using a folder structure in which document entities are hierarchically stored, or one to use metadata, such as a keyword given to a document by a user or a creation date, and to perform classification with the value or rearrangement. Besides, there has been a system in which operation status data on documents are collected and analyzed to calculate relevance between the documents, and it is provided to support the document operation (see, for example, patent document 1: JP-A-2005-25550).

However, in the system in which the document entities are hierarchically managed, when the document entities are stored, it is necessary for the user to grasp the hierarchical structure and to store them at suitable locations. Besides, in the system in which the user gives the metadata, it is necessary to give the suitable metadata when the user manages the document. Further, in the system in which the operation status data on the document are collected and analyzed, the document as the object is limited to electronic one.

### SUMMARY OF THE INVENTION

The invention has been made to solve the foregoing problems, and has an object to provide a document management system, program and method, in which when a user manages a document, metadata based on a document manipulation operation, together with the document, is easily registered, and consequently, it is possible to eliminate the necessity of performing hierarchical management or separately setting metadata.

In order to solve the problems, the document management system of the invention includes a document input/output system control module to control a document input/output equipment, a document data management module to manage a document, a document metadata management module to manage metadata relating to the document managed by the document data management module, a business relevant metadata management module to manage metadata relevant to a business relating to the document managed by the document data management module, a document input/output operation metadata collection module to acquire metadata relating to an input/output operation of the document in the document input/output system control module, a metadata relevance calculation module to calculate a relevance among the metadata managed by the document metadata management module, the business relevant metadata management module, and the document input/output operation metadata collection module, and a metadata relevance presentation module to digitize the relevance calculated by the metadata relevance calculation module and to present it to a user.

Besides, the document management program of the invention causes a computer to execute a metadata relevance calculation step of calculating a relevance among metadata managed by a document metadata management module to manage metadata relating to a document as a management object, a business relevant metadata management module to manage metadata relevant to a business relating to the document managed by the document data management module, and a document input/output operation metadata collection module to acquire metadata relating to an input/output operation of the document, and a metadata relevance presentation step of digitizing the relevance calculated at the metadata relevance calculation step and presenting it to a user.

Besides, the document management method of the invention includes a metadata relevance calculation step of calculating a relevance among metadata managed by a document metadata management module to manage metadata relating to a document as a management object, a business relevant metadata management module to manage metadata relevant to a business relating to the document managed by the document data management module, and a document input/output operation metadata collection module to acquire metadata relating to an input/output operation of the document, and a metadata relevance presentation step of digitizing the relevance calculated at the metadata relevance calculation step and presenting it to a user.

### DESCRIPTION OF THE DRAWINGS

FIG. 1 is a block diagram showing a structure of a document management system of a first embodiment of the invention.

FIG. 2 is a flowchart for explaining a flow of a processing in the document management system of the first embodiment of the invention shown in FIG. 1.

FIG. 3 is a view for explaining management, by XML, of detailed metadata relating to an operation apparatus in a document input/output operation metadata collection module E of FIG. 1.

FIG. 4 is a view for explaining management, by XML, of document metadata in which data relating to an operation apparatus in a document metadata management module C of FIG. 1 is added.

FIG. 5 is a block diagram showing a structure of a document management system of a second embodiment of the invention.

FIG. 6 is a flowchart for explaining a flow of a processing in the document management system of the second embodiment of the invention shown in FIG. 5.

FIG. 7 is a view for explaining management, by XML, of business relevant data in a business relevant metadata management module D of FIG. 5.

FIG. 8 is a view for explaining a management method, by XML, of document metadata in which data relating to the relevance of business in a document metadata management module C of FIG. 5 is added.

FIG. 9 is a view for explaining a relevance setting window to specify relevant business relevant data presented by a metadata relevance presentation module G of FIG. 5.

FIG. 10 is a block diagram showing a structure of a document management system of a third embodiment of the invention.

FIG. 11 is a flowchart for explaining a flow of a processing in the document management system of the third embodiment of the invention shown in FIG. 10.

FIG. 12 is a view for explaining metadata relevance retrieval to indicate retrieval of relevant business relevant data presented by a metadata relevance retrieval request indication module H of FIG. 10.

### DESCRIPTION OF THE EMBODIMENTS

Hereinafter, embodiments of the invention will be described with reference to the drawings.

### First Embodiment

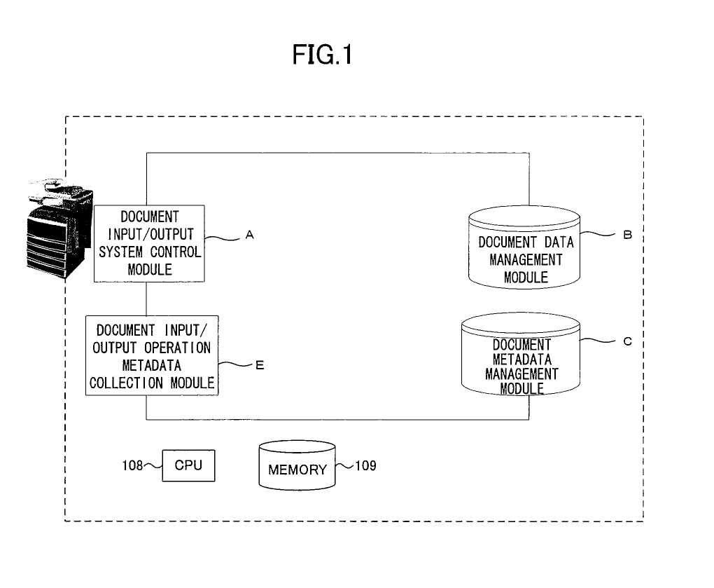

FIG. 1 is a block diagram showing a structure of a document management system of a first embodiment of the invention. The document management system shown in FIG. 1 includes a document input/output system control module A, a document data management module B, a document metadata management module C, a document input/output operation metadata collection module E, a CPU 108, and a MEMORY 109.

The document input/output system control module A is a software module to control an equipment of a system, such as an MFP (Multi Function Peripheral), which prints an electronic document on a paper manuscript by printing or converts a paper manuscript into an electronic document by scanning.

The document data management module B is a software module to manage, as an entity file, a document digitized by the document input/output system control module A or a document created in an electronic document operation environment (for example, OS environment of Windows (registered trademark) or the like).

The document metadata management module C is a software module to manage metadata (peripheral information of a document such as, for example, a creator of the document and a creation date) of the document managed by the document data management module B.

The document input/output operation metadata collection module E is a module to collect metadata relating to a document input/output operation performed by the document input/output system control module A.

The CPU 108 has a role to perform various processings in the document management system, and also has a role to realize various functions by executing programs stored in the MEMORY 109. The MEMORY 109 includes, for example, a ROM, a RAM and the like, and has a role to store various information and programs used in the document management system.

Here, the document data management module B is a file system of a file server, or a module having a document storage function of the document management system. Besides, as a mode of management of the document metadata management module C, metadata is embedded in a document file by using a mechanism to describe data in a file format such as PDF, or metadata is stored in a record of a table associated with the identifier of the document in an external database.

Further, in the document input/output operation metadata collection module E, for example, when a scanning operation is performed in the document input/output system control module A, and a new digitized document file is formed from a paper manuscript, the date when the operation is performed and the data of an operator can be acquired.

Incidentally, here, as the document data management module B, the file system on the file server is used, and the file storage function which the file system conventionally has is used. Besides, as a management method of document data of the document data management module C, data is described in an XML file format, and as a method of managing the XML file, there is a method in which a description is made in a metadata description area inside the document entity, or data storage is performed as a record in a table of a database. With respect to the method of recording in the inside of the document entity, as a file storage format of a document, PDF of Adobe (registered trademark) is adopted, and a mechanism in which metadata is described in a metadata block therein can also be used.

Besides, terms used in this embodiment are defined as follows.

Manuscript: a paper medium document obtained by printing a document on a sheet.

Entity of document: an actual entity dependent on a format in a form in which an electronic document is described. For example, in a file system of Windows, it is a file managed thereon, and in a document management system, it is a data record stored in a database to manage images thereon. As the form and the format, there is a TIFF, a PDF or a storage style intrinsic to a document management system.

Metadata of document: attribute and property information such as a creator of the document, a group to which the creator belongs, a place where the creator is mainly stationed, a user, a grope to which the user belongs, a place where the user is mainly stationed, a date at the time of creation, weather at the time of creation, surrounding environment of the creator at the time of creation, a date at the time of use, weather at the time of use, surrounding environment of the user, and a creation application.

Document information processing apparatus: an apparatus to process the document and its metadata, and register and manage them. As managed document information, there are arrangement position information of documents existing on the system (for example, managed as a path of a folder structure dependent on the file system), a link (for example, link to each application form displayed on Top page of a company portal), an arrangement structure corresponding to the content (for example, a classification structure by category), and the like. Besides, a system to provide a management structure for storing a document itself (for example, document management system) is also included in the apparatus. It can be used from plural users, and has a user authentication function and a sharing function through a network. Besides, in cooperation with various devices of the document input/output system, extension can be made to ensure a medium conversion function between a paper and an electronic medium, and an external communication function of a FAX or the like.

Document input/output system: a system including an apparatus such as a printing apparatus (printer), an image reading apparatus (scanner) or an image communication apparatus (FAX), and capable of treating a document or a manuscript.

Module: a software module which each device of the document information processing apparatus or a component of the document input/output system has.

Besides, in this embodiment, notations having following meanings are used.

Word delimited by [ ]: a name of metadata.

Word delimited by “ ”: a value and content of metadata.

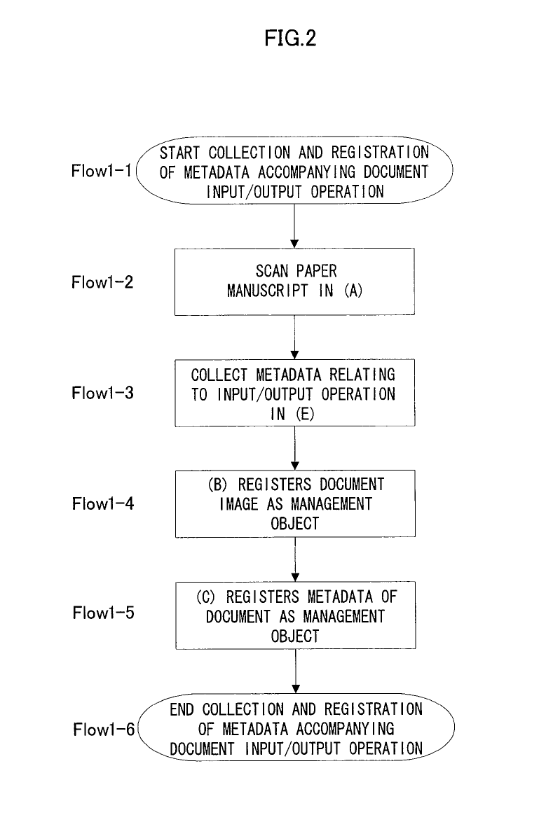

Next, the flow of a processing in the first embodiment will be described with reference to a flowchart shown in FIG. 2. Here, a processing at a time when a user scans and digitizes a paper manuscript will be described as a document input/output operation.

First, the user starts metadata collection and registration accompanying the document input/output operation (Flow1-1), and scans the paper manuscript in the document input/output system control module A (Flow1-2). The document input/output operation metadata collection module E collects the metadata in this operation (Flow1-3).

As the metadata, since a new electronic document is formed by performing the operation, that is, the scan operation, the name “XXX Taro” of the user, who has performed the scan operation as [creator], is collected as a value. Besides, according to the person who performs the operation in the document input/output system control module A, it is conceivable that authentication is required for performing the operation. At that time, input of a password is required for the authentication of the user XXX Taro, and it is assumed that XXX Taro inputs his own password and can perform the scan operation.

In the document input/output operation metadata collection module E, a value “pass” of metadata [password] inputted in the manner as described above is collected. Besides, the date when the scanning is performed is collected as a value “2005/9/15 14:30:10” of metadata [creation date]. Besides, as to identification of an apparatus in which the operation has been performed, since the document input/output system control module A itself recognizes the set value of itself, it is collected as a value “MFP_{—}01” of metadata [operation apparatus].

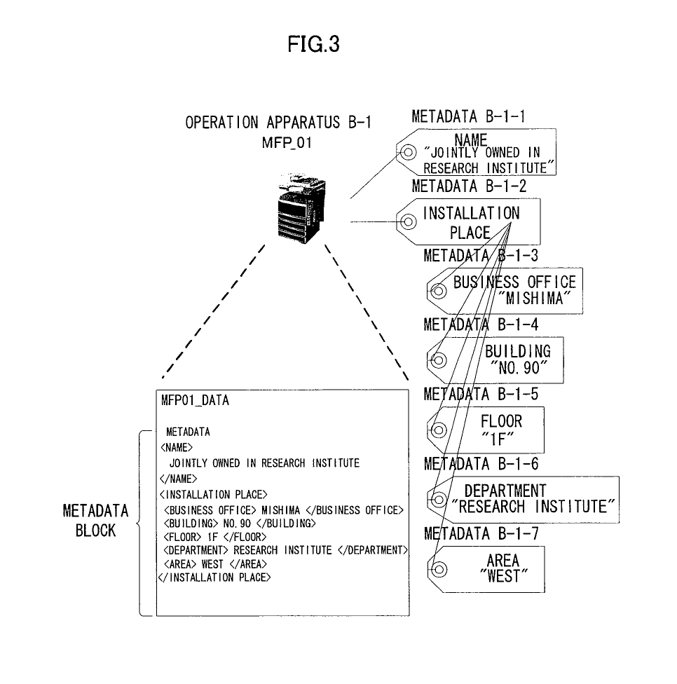

It is assumed that the detailed data relating to this [operation apparatus] are separately managed as data of the operation apparatus in the document input/output operation metadata collection module E as shown in FIG. 3. With respect to this [operation apparatus], although data of [name] and [installation place] exist as metadata, the data is separately managed as operation apparatus data in the document input/output operation metadata collection module E. Here, as shown in FIG. 3, it is assumed that [name] of an operation apparatus B-1 is “jointly owned in research institute”, and with respect to [installation place] thereof, the metadata relating to places are hierarchically set such that [business office] is “Mishima”, [building] is “No. 90”, [floor] is “1F”, [department] is “research institute”, and [area] is “west”.

Next, the image data obtained by the scan operation is managed by the document data management module B (Flow 1-4). Here, the scanned image is made a JPEG image file or a PDF file and is arranged into a specific folder of a file server of the document data management module B so that the management is made. In this embodiment, the file is managed as a document, Doc_001.PDF in which the scanned image is pasted as a page image.

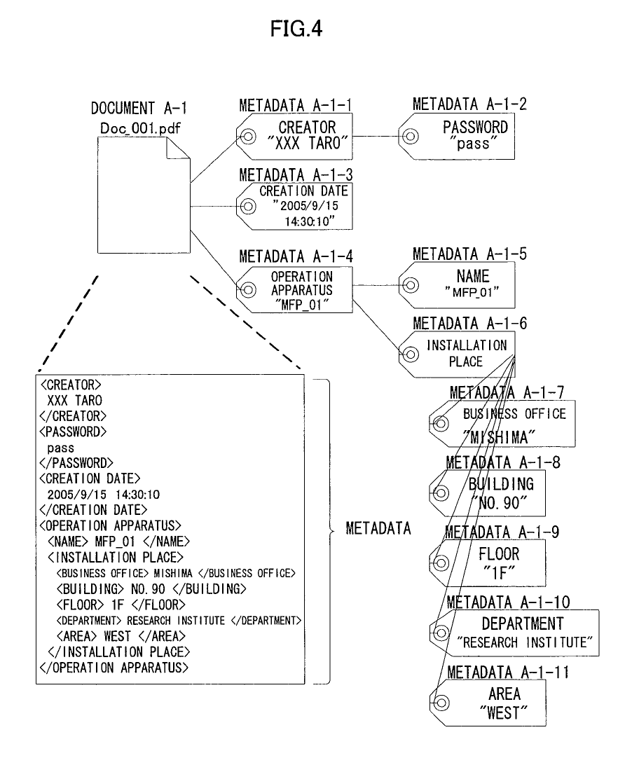

Next, the metadata obtained by the document input/output operation metadata collection module E are registered in the document metadata management module C and are managed (Flow1-5). Here, the metadata collected in Flow1-3 are managed as shown in FIG. 4. As shown in FIG. 4, in addition to [creator], [password], [creation date] and [operation apparatus], the detailed metadata [name] and [installation place] of the operation apparatus, which are managed in the document input/output operation metadata collection module E, are also simultaneously associated with the document Doc_001.PDF and are managed. By doing so, it is possible to immediately grasp that the managed document is created by which operation apparatus and at which place.

Accordingly, according to the first embodiment, when the user manages the document, the metadata based on the document manipulation operation, together with the document, are easily registered, and consequently, it is unnecessary to perform hierarchical management or to separately set metadata, and the metadata relating to the input/output operation of the document can be collected and managed, and further, it becomes possible to guess the relevance between the input/output operation of the document and a business such as an actual meeting or an already managed document and to present it to the user.

Besides, by using the document input/output system control module A, also with respect to the manipulation of paper medium documents other than the electronic documents, when those are managed, it becomes possible to register metadata.

### Second Embodiment

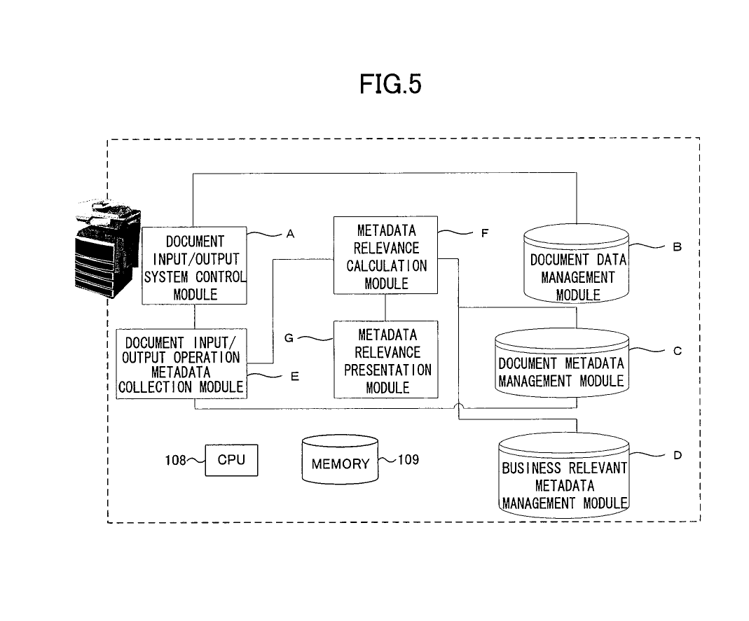

FIG. 5 is a block diagram showing a structure of a document management system of a second embodiment of the invention. The document management system shown in FIG. 5 includes, in addition to the structure of the document management system of the first embodiment shown in FIG. 1, a business relevant metadata management module D, a metadata relevance calculation module F, and a metadata relevance presentation module G.

Here, the business relevant metadata management module D is a software module which, with respect to a meeting, an event or the like, manages, as metadata, the data of a date when it is held and a place.

The metadata relevance calculation module F is a module to calculate, as a value of a relevance degree, a relevance of values of metadata managed by the document metadata management module C, the business relevant metadata management module D, and a document input/output operation metadata collection module E.

The metadata relevance presentation module G is a software module to constitute a GUI for presenting, with respect to the relevance calculated in the metadata relevance calculation module F, a document judged to be relevant according to the value of the relevance degree and business relevant data to the user.

Incidentally, here, the business relevant metadata management module D is interlocked with, for example, a scheduler, and acquires and manages data such as a date and place of an event set by the scheduler.

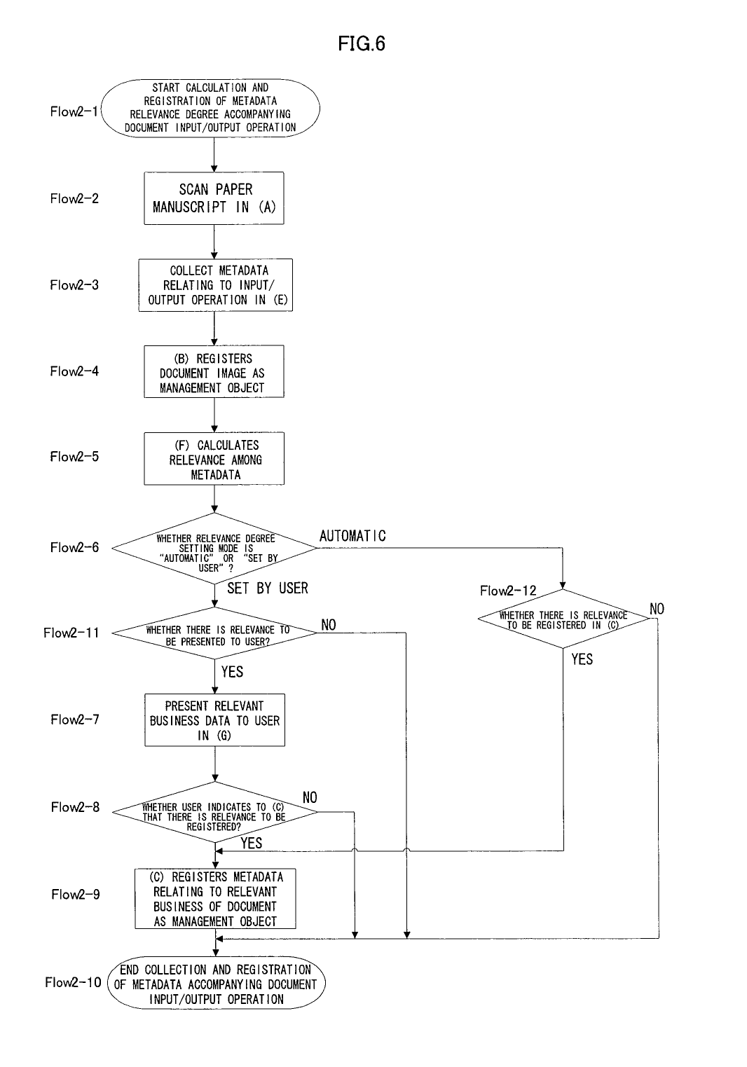

Next, the flow of a processing in this second embodiment will be described with reference to a flowchart shown in FIG. 6. Here, a description will be given to a processing at the time when a relevance degree between metadata collected in the document input/output operation and business relevant metadata, such as event information, managed in the business relevant metadata management module D is calculated, and the result is registered in the document metadata management module C.

First, operations of from Flow2-1 to Flow2-4 are similar to operations of from Flow1-1 to Flow1-4 of the first embodiment shown in FIG. 2.

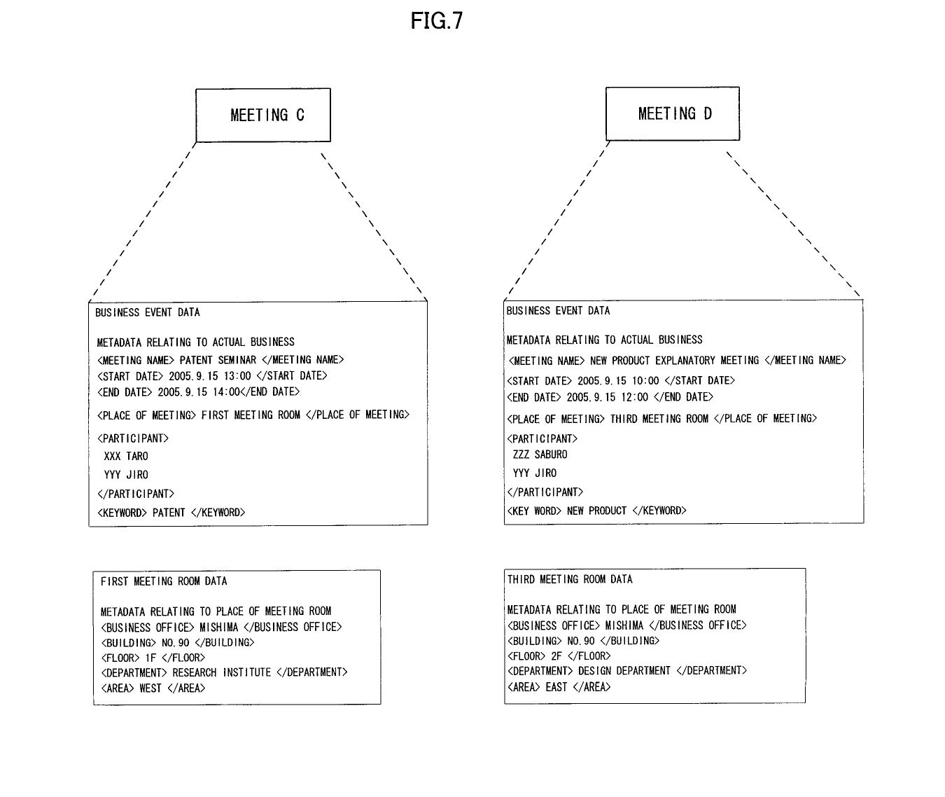

Next, a description will be given to a processing in which the metadata relevance calculation module F calculates the relevance between the metadata (Flow2-5). In the business relevant metadata management module D, as business relevant data, a business event (meeting or festival) and data of the place where the event is held, and the like are managed as shown in FIG. 7.

Here, it is assumed that information of a meeting C and a meeting D is managed as the business relevant metadata. The meeting C is set such that [name of meeting] is “patent seminar”, [start date] is “2005.9.15 13:00”, [end date] is “2005.9.15 14:00”, [place of meeting] is “first meeting room”, [participant] is “XXX Taro” and “YYY Jiro”, and [key word] is “patent”. Besides, as detailed data of the place, the data is set such that with respect to the first meeting room, [business office] is “Mishima”, [building] is “No. 90”, [floor] is “1F”, [department] is “research institute”, and [area] is “west”. Besides, the meeting D is set such that [meeting name] is “new product explanatory meeting”, [start date] is “2005.9.15 10:00”, [end date] is “2005.9.15 12:00”, [place of meeting] is “third meeting room”, [participant] is “ZZZ Saburo” and “YYY Jiro”, and [keyword] is “new product”. Further, as detailed data of the place, with respect to the third meeting room, the data is set such that [business office] is “Mishima”, [building] is “No. 90”, [floor] is “2F”, [department] is “design department”, and [area] is “east”.

Here, the metadata relevance calculation module F calculates the relevance between the values of the metadata relating to these businesses and the values of the metadata relating to the document collected in the document input/output operation metadata collection module E (metadata relevance calculation step). In this calculation method, some calculation rules are set, and those are applied. Here, first, a description will be given to a method in which the relevance of the information relating to the places is calculated. Incidentally, the relevance between the metadata calculated in the metadata relevance calculation module F is presented to the user by the metadata relevance presentation module G (metadata relevance presentation step).

As the metadata collected in the document input/output operation metadata collection module E, the detailed [installation place] metadata of [operation apparatus] is managed. Here, with respect to both the [installation place] metadata and the metadata of the place where the event is held, which is managed in the business relevant metadata management module D, the data are hierarchically described like [business office], [building], [floor], [department] and [area] and are managed. Then, the point of the relevance degree is set according to the coincidence rate of information, for example, 1 point when values of [business place] are coincident with each other, 2 points when values up to [building] are coincident, 4 points when values up to [floor] are coincident, 8 points when values up to [department] are coincident, and 16 points when values up to [area] are coincident. Here, for example, the coincidence rate of the metadata relating to the place means “whether the places are close to each other”, and the coincidence rate of the metadata relating to the time means “whether it is close to the practice time of an event such as a meeting”. Incidentally, with respect to the coincidence rate of the metadata relating to the time, a judgment can be made such that when a time difference between the metadata of the time of both as the comparison objects of the coincidence rate is within a specified time, it has some point.

For example, with respect to Doc_001.PDF (see FIG. 4) and the meeting C, since all values from [business place] to [area] are coincident with each other, the relevance degree is 16 points. Besides, with respect to Doc_001.PDF and the meeting D, since values up to [building] are coincident with each other, the relevance degree becomes 2 points. Similarly to the relevance to the place using the [installation place] data and the [place of meeting] data, a relevance with respect to a time using [creation date], [start date] and [end date] data, a relevance with respect to a person using [creator] and [participant] data, a relevance with respect to a key word using character information obtained by performing OCR of the scanned image and [keyword] data, and the like are set as calculation rules, and the relevance is numerically calculated.

Next, a mode of way of setting when the relevance between the document and the business relevant data is set as the metadata of the document from these calculated relevance degrees is selected (Flow2-6). As the mode, there is an “automatic” mode in which when the relevance degree is a certain specific value or more, they are regarded as being relevant to each other and are automatically set as metadata of the document, or a “set by user” mode in which when a relevance degree is a certain specific value or more, they are regarded as having a possibility of relevance and are listed as candidates which the user is urged to set as the metadata of the document, and waiting is made for user's instruction.

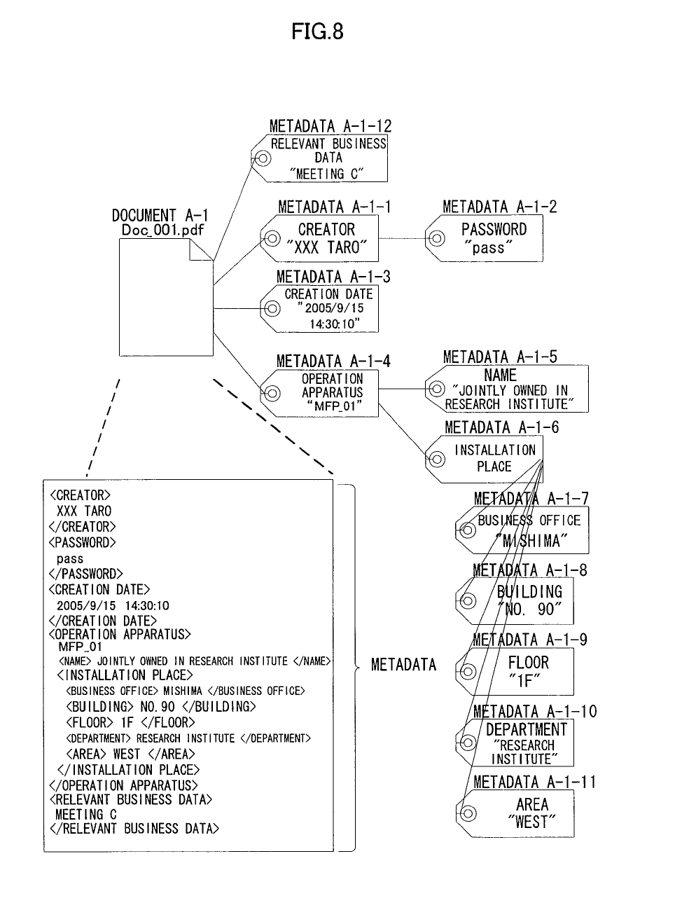

For example, in the case where the “automatic” mode is set (in Flow2-6, direction to “automatic”), when the relevance degree of 8 points or more is calculated with respect to the place, and it is set that the document and the business relevant data are relevant to each other, the document Doc_001.PDF and the meeting C are regarded as being relevant to each other and are automatically set (Flow2-12). When it is judged that there is a relevance (“yes” direction in Flow2-12), this relevance is set and registered as the metadata to be managed in the document metadata management module C (Flow2-9). As a result, setting is made as the metadata in the document Doc_001.PDF as shown in FIG. 8.

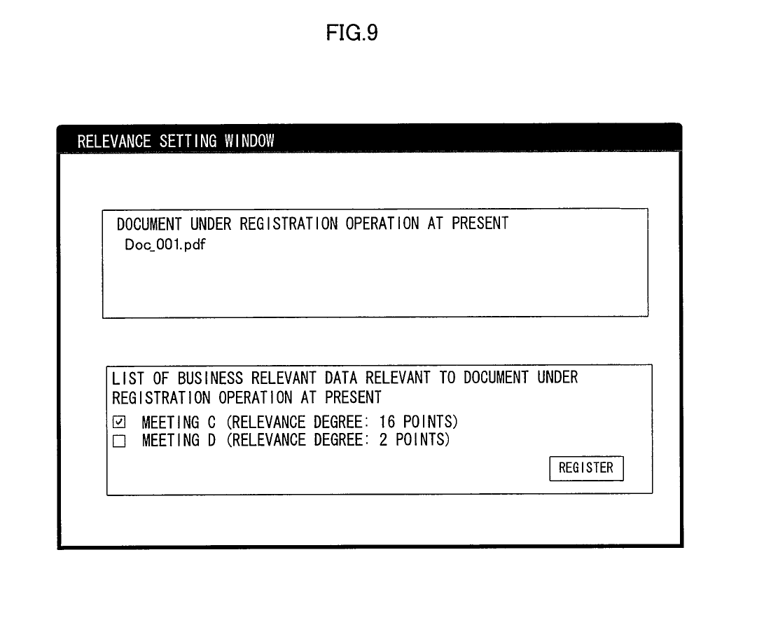

Besides, in the case where the “set by user” mode is set (direction to “set by user” in Flow2-6), it is assumed that as a condition under which presentation is made to the user in the metadata relevance presentation module G, those having 1 point or more are presented. Then, with respect to the relevance degree relating to the place, since the meeting C and the meeting D have a relevance degree of 1 point or more, it is judged that they should be presented to the user (“yes” direction in Flow2-11). The business relevant data judged to be capable of having such relevance is presented to the user by the metadata relevance presentation module G (Flow2-7). This is presented by a module having a GUI as shown in FIG. 9. Here, the document Doc_001.PDF under registration operation at present is displayed, and the business relevant data having a relevance degree of 1 point or more with respect thereto are displayed as a list.

The user sees the content of the business relevant data and the point of the relevance degree, and when a judgment is made that business relevant data is relevant to the document Doc_001.PDF (“yes” direction in Flow2-8), a mark is given so that the business relevant data is placed in a selected state, and a “registration” button is pressed. By this, setting that the meeting C indicated as having the relevance is business data relevant to the document Doc_001.PDF is performed to the document metadata management module C (Flow2-9). As a result, also here, setting is similarly made as the metadata of the document as shown in FIG. 8.

Accordingly, according to the second embodiment, the business relevant data such as a meeting schedule and the data of the document manipulation operation are associated with each other, and the convenience for management, retrieval after the registration and the like can be raised.

### Third Embodiment

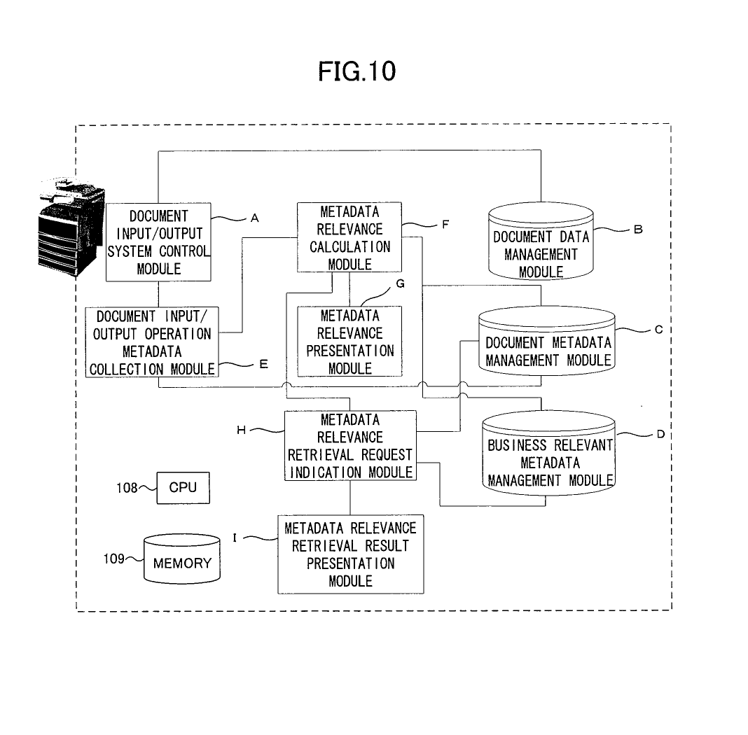

FIG. 10 is a block diagram showing a structure of a document management system of a third embodiment of the invention. The document management system shown in FIG. 10 includes, in addition to the structure of the document management system of the second embodiment shown in FIG. 5, a metadata relevance retrieval request indication module H and a metadata relevance retrieval result presentation module I.

Here, the metadata relevance retrieval request indication module H is a software module in which with respect to a relevance between a document and business relevant data, which is calculated by a metadata relevance calculation module F, a user indicates a request for retrieving the presence/absence of the relevance while a value of metadata of the document or the business relevant data is used as a key.

The metadata relevance retrieval result presentation module I is a software module constituting a GUI to present the result of the retrieval performed in the metadata relevance retrieval request indication module H.

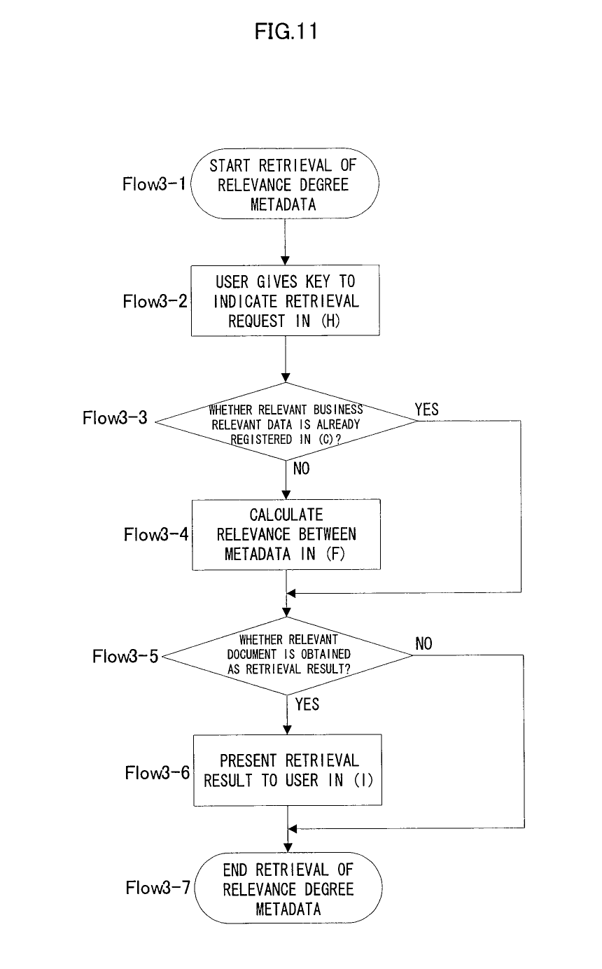

Next, the flow of a processing in the third embodiment will be described with reference to a flowchart shown in FIG. 11. Here, as a document input/output operation, a processing in which the user scans and digitizes a paper manuscript will be described.

First, a description will be given to the assumption on which this processing occurs. A document registered in a document data management module B is sometimes newly searched and operated for browsing or printing again. At that time, it is necessary for the user to quickly search the objective document. In order to search the document, a search can be made by directly tracing the folder structure of the document data management module B, or in the case where OCR is performed for the image data, a keyword is set and full-text retrieval can be performed, or the registered metadata is set as a key, and retrieval can be performed by keyword matching. Here, there is provided a method in which when the document is searched, business relevant data judged to be relevant to the document is made a retrieval key and retrieval is performed by matching.

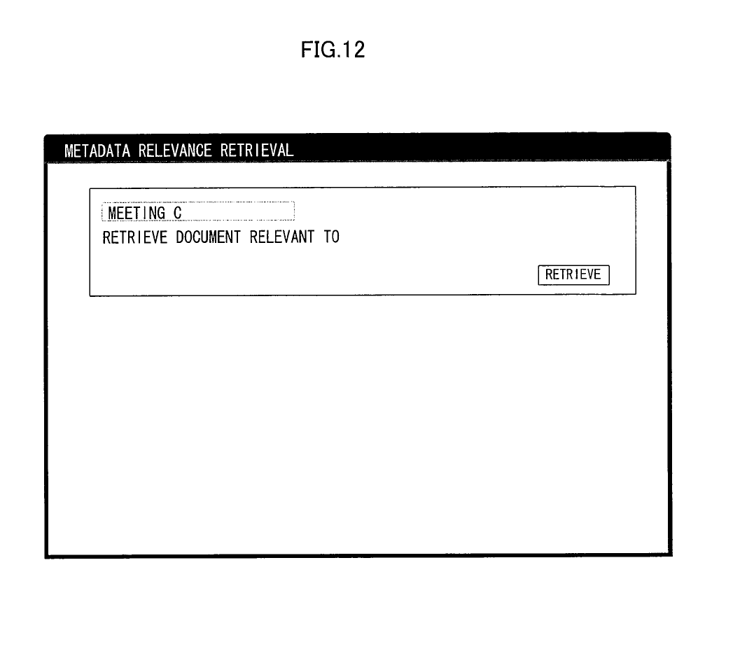

The user starts the retrieval of relevance degree metadata (Flow3-1), and can indicate a retrieval request to the system by the GUI provided by the metadata relevance retrieval request indication module H (Flow3-2). FIG. 12 is a view showing an example of the GUI provided by the metadata relevance retrieval request indication module H. Here, the user indicates the business relevant data relevant to a desired document as a retrieval key, so that the retrieval of the document can be performed.

With respect to this retrieval, the way of retrieval varies according to whether the information of business relevant data is previously set as the metadata in the document metadata management module C (Flow3-3). In the case where the business relevant data relevant to the document is not set as in the first embodiment (“NO” direction in Flow3-3), the relevance between the metadata is calculated in the metadata relevance calculation module F. As a processing here, a processing similar to that performed by the metadata relevance calculation module F in the embodiment 2 is performed (Flow3-4). Based on the relevance degree of values of the metadata of the document and the business relevant data obtained in this way, the value of the metadata of the business relevant data is indicated as a retrieval key, and a relevant document is retrieved by matching.

As a result, when the relevant document is obtained as the retrieval result (“YES” direction in Flow3-5), the result is presented to the user in the metadata relevance retrieval result presentation module I. In this GUI, like a normal retrieval result list, a list of documents relevant to the meeting C is presented to the user. The user confirms the presented list of documents, and when a desired document exists, the document of the GUI is clicked or the like to place the document into an open state, and the operation or printing can be performed.

Besides, a document management program of this embodiment can be constructed to cause a computer to execute a metadata relevance calculation step of calculating a relevance among metadata managed by a document metadata management module to manage metadata relating to a document as a management object, a business relevant metadata management module to manage metadata relevant to a business relating to the document managed by the document data management module, and a document input/output operation metadata collection module to acquire metadata relating to an input/output operation of the document, and a metadata relevance presentation step of digitizing the relevance calculated at the metadata relevance calculation step and presenting it to a user.

Besides, a document management method can be made to include a metadata relevance calculation step of calculating a relevance among metadata managed by a document metadata management module to manage metadata relating to a document as a management object, a business relevant metadata management module to manage metadata relevant to a business relating to the document managed by the document data management module, and a document input/output operation metadata collection module to acquire metadata relating to an input/output operation of the document, and a metadata relevance presentation step of digitizing the relevance calculated at the metadata relevance calculation step and presenting it to a user.

In the foregoing respective embodiments, the respective steps of the processing (document management method) in the document management system are realized by causing the CPU 108 to execute the document management program stored in the MEMORY 109.

Incidentally, in this embodiment, although the description has been given to the case where the function to carry out the invention is previously recorded in the inside of the apparatus, the invention is not limited to this, and a similar function may be downloaded from a network to the apparatus, or a similar function stored in a recording medium may be installed in the apparatus. As the recording medium, as long as the recording medium can store a program and can be read by the apparatus, such as a CD-ROM, its form may be any form. Besides, the function previously obtained by installation or download may realize the function in cooperation with the OS (Operation System) or the like in the inside of the apparatus.

Although the invention has been described in detail in the specific mode, it would be apparent for one skilled in the art that various modifications and improvements can be made unless they depart from the sprit and scope of the invention.

As described above in detail, according to the invention, when the user manages a document, metadata based on a document manipulation operation, together with the document, is easily registered, and consequently, the technique, which can eliminate the necessity of performing hierarchical management or separately setting metadata, can be provided.

What is claimed is:

1. A document management system comprising:
a document input/output system control module to control a document input/output equipment;
a document data management module to manage a document;
a document metadata management module to manage metadata relating to the document managed by the document data management module;
a business relevant metadata management module to manage metadata relevant to a business relating to the document managed by the document data management module;
a document input/output operation metadata collection module to acquire metadata relating to an input/output operation of the document in the document input/output system control module;
a metadata relevance calculation module to calculate a relevance among the metadata managed by the document metadata management module, the business relevant metadata management module, and the document input/output operation metadata collection module; and
a metadata relevance presentation module to digitize the relevance calculated by the metadata relevance calculation module and to present it to a user.

2. The document management system according to claim 1, characterized in that the metadata relevance calculation module calculates the relevance among the metadata based on a coincidence rate of character strings among the metadata managed by the document metadata management module, the business relevant metadata management module, and the document input/output operation metadata collection module.

3. The document management system according to claim 1, characterized in that the metadata relevance calculation module calculates a relevance of metadata relating to a place.

4. The document management system according to claim 1, characterized in that the metadata relevance calculation module calculates a relevance of metadata relating to a time.

5. The document management system according to claim 1, characterized in that the metadata relevance calculation module calculates a relevance of metadata relating to the user.

6. The document management system according to claim 1, characterized in that the metadata relevance calculation module calculates a relevance of metadata relating to a keyword.

7. The document management system according to claim 1, characterized in that the document metadata management module manages the relevance calculated by the metadata relevance calculation module as the metadata of the document.

8. The document management system according to claim 1, further comprising:
a metadata relevance retrieval request indication module to retrieve the relevance calculated by the metadata relevance calculation module; and
a metadata relevance retrieval result presentation module to present a retrieval result obtained by the metadata relevance retrieval request indication module.

9. A document management program causing a computer to execute:
a metadata relevance calculation step of calculating a relevance among metadata managed by a document metadata management module to manage metadata relating to a document as a management object, a business relevant metadata management module to manage metadata relevant to a business relating to the document managed by the document data management module, and a document input/output operation metadata collection module to acquire metadata relating to an input/output operation of the document; and
a metadata relevance presentation step of digitizing the relevance calculated at the metadata relevance calculation step and presenting it to a user.

10. The document management program according to claim 9, characterized in that at the metadata relevance calculation step, the relevance among the metadata is calculated based on a coincidence rate of character strings among the metadata managed by the document metadata management module, the business relevant metadata management module, and the document input/output operation metadata collection module.

11. The document management program according to claim 9, characterized in that at the metadata relevance calculation step, a relevance of metadata relating to a place is calculated.

12. The document management program according to claim 9, characterized in that at the metadata relevance calculation step, a relevance of metadata relating to a time is calculated.

13. The document management program according to claim 9, characterized in that at the metadata relevance calculation step, a relevance of metadata relating to the user is calculated.

14. The document management program according to claim 9, characterized in that at the metadata relevance calculation step, a relevance of metadata relating to a keyword is calculated.

15. A document management method comprising:
a metadata relevance calculation step that calculates a relevance among metadata managed by a document metadata management module to manage metadata relating to a document as a management object, a business relevant metadata management module to manage metadata relevant to a business relating to the document managed by the document data management module, and a document input/output operation metadata collection module to acquire metadata relating to an input/output operation of the document; and
a metadata relevance presentation step that digitizes the relevance calculated at the metadata relevance calculation step and presenting it to a user.

16. The document management method according to claim 15, characterized in that at the metadata relevance calculation step, the relevance among the metadata is calculated based on a coincidence rate of character strings among the metadata managed by the document metadata management module, the business relevant metadata management module, and the document input/output operation metadata collection module.

17. The document management method according to claim 15, characterized in that at the metadata relevance calculation step, a relevance of metadata relating to a place is calculated.

18. The document management method according to claim 15, characterized in that at the metadata relevance calculation step, a relevance of metadata relating to a time is calculated.

19. The document management method according to claim 15, characterized in that at the metadata relevance calculation step, a relevance of metadata relating to the user is calculated.

20. The document management method according to claim 15, characterized in that at the metadata relevance calculation step, a relevance of metadata relating to a keyword is calculated.
